(19) United States
(12) Patent Application Publication
(10) Pub. No.: US 2018/0340788 A1
(43) Pub. Date: Nov. 29, 2018

(54) A NAVIGATION APPARATUS AND ASSOCIATED METHODS

(71) Applicant: Nokia Technologies Oy, Espoo (FI)

(72) Inventors: Xiaobai LIU, Los Angeles, CA (US); Stephanie ZHU, Calabasas, CA (US)

(21) Appl. No.: 15/768,248

(22) PCT Filed: Oct. 19, 2015
(86) PCT No.: PCT/CN2015/092163

§ 371 Date: Apr. 13, 2018

(51) Int. Cl. G01C 21/34

(52) U.S. Cl. CPC G01C 21/3476

(57) ABSTRACT

An apparatus configured to: based on a plurality of geographical position data points associated with the position of a moving object; and based on a plurality of visual location data points obtained from a plurality of image frames captured from the moving object, the image frames showing a field of view of the moving object; determining a multi-modal trajectory by: matching the plurality of visual location data points with corresponding geographical navigation position data point of the plurality of geographical position data points; and determining the multi-modal trajectory as a best-fit trajectory having a deviation from the matched plurality of visual location data points and the plurality of geographical position data points within a predetermined tolerance; and smoothing the determined multi-modal trajectory to obtain a stable moving object trajectory indicative of a position and a heading of the moving object.

### TECHNICAL FIELD

The present disclosure relates to the field of navigation systems, associated methods and apparatus, including the provision of navigation directions to a user.

Certain disclosed aspects/examples relate to portable electronic devices, in particular, so-called hand-portable electronic devices which may be hand-held in use (although they may be placed in a cradle in use). Such hand-portable electronic devices include mobile telephones, so-called Personal Digital Assistants (PDAs), smartphones and other smart devices, and tablet PCs.

Portable electronic devices/apparatus according to one or more disclosed examples may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture functions (e.g. using a (e.g. in-built) digital camera), and gaming functions.

### BACKGROUND

Navigation technologies may allow images of geographical locations to be viewed.

The listing or discussion of a prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

According to a first aspect, there is provided an apparatus comprising a processor and memory including computer program code, the memory and computer program code configured to, with the processor, enable the apparatus at least to:
based on a plurality of geographical position data points associated with the position of a moving object; and
based on a plurality of visual location data points obtained from a plurality of image frames captured from the moving object, the image frames showing a field of view of the moving object;
determine a multi-modal trajectory by:
   matching the plurality of visual location data points with corresponding geographical position data points of the plurality of geographical position data points; and
   determining the multi-modal trajectory as a best-fit trajectory having a deviation from the matched plurality of visual location data points and the plurality of geographical position data points within a predetermined tolerance; and
smooth the determined multi-modal trajectory to obtain a stable trajectory of the moving object, the stable trajectory indicative of a position and a heading of the moving object.

The apparatus may be configured to provide the stable trajectory of the moving object with sub-meter accuracy. In some examples, the geographical position data points are recorded as GPS data points at a frequency of 1Hz. In some examples, the image frames may be captured at a frequency of 30 frames per second, although other frequencies can be used (e.g., 60 frames per second, 10 frames per second). In some examples a selection of frames may be sampled from the captured frames; for example, 10 to 15 frames per second may be sampled from a video stream captured at 30 frames per second to reduce computational costs while maintaining an accuracy allowing for sub-meter trajectory determination. In some examples, the plurality of visual location data points are recorded in a monocular video having a frame size 1920×1080 pixels.

In certain examples, sub-meter accuracy of the stable trajectory of the moving object may be obtained using: at least 10 frames per second; at least 15 frames per second; at least 20 frames per second; at least 30 frames per second; and at least 60 frames per second capture rates of the visual location data points. The skilled person will appreciate that more accurate results may require more intensive computational/processor resources (i.e. the stable trajectory calculation time may be longer if more frames per second are used).

The apparatus may be configured to match the plurality of visual location data points with a plurality of corresponding geographical position data points of the plurality of geographical position data points by, at least in part,
calculating a similarity matrix using the plurality of visual location data points and the plurality of corresponding geographical position data points to minimise a difference between at least a subset of the plurality of visual location data points and the plurality of corresponding geographical position data points.

The apparatus may be configured to calculate the similarity matrix using a random sample consensus (RANSAC) method.

The apparatus may be configured to determine the multi-modal trajectory by, at least in part, minimising a function associated with the multi-modal trajectory comprising at least two energy terms, the at least two terms comprising:
a first term associated with matching visual location data points between consecutive image frames; and
a second term associated with constraining a visual trajectory shape obtained from the visual location data points to within a predetermined deviation from the visual location data points.

The function associated with the multi-modal trajectory may comprise at least a third term associated with constraining a direction obtained from the geographical position data points.

Minimising the function may comprise using a least squares minimisation.

Constraining the visual trajectory shape obtained from the visual location data points to within a predetermined deviation from the visual location data points may comprise using a B-spline model to determine a smooth visual trajectory shape from the visual location data points.

The apparatus may be configured to determine the visual trajectory shape by, at least in part:
identifying visual location data points in the plurality of image frames using image feature recognition; and
matching corresponding visual location data points between image frames in the plurality of consecutive image frames.

The apparatus may be configured to determine the visual trajectory shape by, at least in part:
for a plurality of image windows offset from each other by at least one image frame, each image window comprising a plurality of consecutive image frames:
identifying visual location data points in the plurality of image frames of each image window using image feature recognition;
matching corresponding visual location data points between image frames in the plurality of consecutive image frames; and
matching the corresponding visual location data points between image frames present in two or more overlapping image windows.

Corresponding visual location data points in consecutive frames may be identified using one or more of: a scale invariant feature transform (SIFT) model, and a speeded up robust features (SURF) model.

The apparatus may be configured to smooth the multi-modal trajectory by, at least in part, using a Hidden Markov Model. Using a Hidden Markov Model may comprise using Bayesian filtering.

The apparatus may be configured to smooth the determined multi-modal trajectory based on the number of image frames in the plurality of image frames of an image window. Thus, the number of frames may comprise a parameter of a mathematical filtering process.

The plurality of geographical position data points may comprise second order relative motion derived from a plurality of absolute geographical navigation positions.

The plurality of visual location data points may be a subset of a plurality of initial visual location data points, the subset of initial visual location data points excluding visual location data points from the plurality of initial visual points which are identified as lying outside a predetermined outlier threshold.

The moving object may be one or more of: a vehicle, an airborne object, a land-based object, a manually-driven object, an automatically-driven object, a drone, a robot, a mapping vehicle, a rescue vehicle, a portable electronic device, a mobile telephone, a Smartphone, a tablet computer, a personal digital assistant, a laptop computer, a digital camera, or a module/circuitry for one or more of the same.

The apparatus may be the moving object. The apparatus may comprise the moving object. The apparatus may be remote from, and in communication with, the moving object.

The moving object may be configured to operate in one or more of: an indoor environment, an outdoor environment, and a crowded environment.

According to a further aspect, there is provided an apparatus comprising:
based on a plurality of geographical position data points associated with the position of a moving object; and
based on a plurality of visual location data points obtained from a plurality of image frames captured from the moving object, the image frames showing a field of view of the moving object;
means for determining a multi-modal trajectory by:
   matching means configured to match the plurality of visual location data points with corresponding geographical navigation position data point of the plurality of geographical position data points; and
   determining means configured to determining the multi-modal trajectory as a best-fit trajectory having a deviation from the matched plurality of visual location data points and the plurality of geographical position data points within a predetermined tolerance; and
means for smoothing the determined multi-modal trajectory to obtain a stable trajectory of the moving object, the stable trajectory indicative of a position and a heading of the moving object.

According to a further aspect, there is provided a method comprising:
based on a plurality of geographical position data points associated with the position of a moving object; and
based on a plurality of visual location data points obtained from a plurality of image frames captured from the moving object, the image frames showing a field of view of the moving object;
determining a multi-modal trajectory by:
   matching the plurality of visual location data points with corresponding geographical navigation position data point of the plurality of geographical position data points; and
   determining the multi-modal trajectory as a best-fit trajectory having a deviation from the matched plurality of visual location data points and the plurality of geographical position data points within a predetermined tolerance; and
smoothing the determined multi-modal trajectory to obtain a stable trajectory of the moving object, the stable trajectory indicative of a position and a heading of the moving object.

The steps of any method disclosed herein do not have to be performed in the exact order disclosed, unless explicitly stated or understood by the skilled person.

According to a further aspect, there is provided a computer readable medium comprising computer program code stored thereon, the computer readable medium and computer program code being configured to, when run on at least one processor, perform a method comprising:

based on a plurality of geographical position data points associated with the position of a moving object; and
based on a plurality of visual location data points obtained from a plurality of image frames captured from the moving object, the image frames showing a field of view of the moving object;
determining a multi-modal trajectory by:
   matching the plurality of visual location data points with corresponding geographical navigation position data point of the plurality of geographical position data points; and
   determining the multi-modal trajectory as a best-fit trajectory having a deviation from the matched plurality of visual location data points and the plurality of geographical position data points within a predetermined tolerance; and
smoothing the determined multi-modal trajectory to obtain a stable trajectory of the moving object, the stable trajectory indicative of a position and a heading of the moving object.

Corresponding computer programs for implementing one or more steps of the methods disclosed herein are also within the present disclosure and are encompassed by one or more of the described examples. One or more of the computer programs may be software implementations, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

One or more of the computer programs or data structures may be provided on a computer readable medium, which may be a physical computer readable medium such as a disc or a memory device, or may be embodied as a transient signal. Such a transient signal may be a network download, including an internet download.

Throughout the present specification, descriptors relating to relative orientation and position, such as “top”, “bottom”, “left”, “right”, “above” and “below”, as well as any adjective and adverb derivatives thereof, are used in the sense of the orientation of the apparatus as presented in the drawings. However, such descriptors are not intended to be in any way limiting to an intended use of the described examples.

Throughout the present specification, the term “minimise” as well as any adjective and adverb derivatives thereof may be taken to mean reduced to within a predetermined minimum threshold. Similarly “maximise” as well as any adjective and adverb derivatives thereof may be taken to mean increased (made larger or greater) to within a predetermined maximum threshold.

The present disclosure includes one or more corresponding aspects, examples or features in isolation or in various combinations whether or not specifically stated (including claimed) in that combination or in isolation. Corresponding means and corresponding functional units (e.g., multi-modal trajectory determiner, multi-modal trajectory smoother, corresponding data point matcher) for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1a illustrates schematically an example apparatus configured to perform one or more methods described herein;

FIG. 1b illustrates example intelligent moving platforms (IMPs);

FIG. 2a illustrates a method according to examples disclosed herein;

FIG. 2b illustrates a method according to examples disclosed herein;

FIGS. 3a and 3b illustrate examples of comparing visual position data points between batches of frames according to examples disclosed herein;

FIG. 4 illustrates matching geographical navigation position data with visual odometry data according to examples disclosed herein;

FIG. 5 illustrates schematically a Hidden Markov Model;

FIG. 6a illustrates trajectories of an IMP obtained from geographical navigation position data (GPS data) compared with a trajectory obtained using methods disclosed herein with GPS and visual odometry data

FIG. 6b illustrates comparing a current field of view with a warped visual odometry data according to examples disclosed herein;

FIGS. 7a-7c illustrate a worked example of IMP trajectories obtained using methods disclosed herein;

FIGS. 8a-8c illustrate a further worked example of IMP trajectories obtained using methods disclosed herein;

FIG. 9 illustrates an example method according to examples disclosed herein; and

FIG. 10 illustrates a computer-readable medium comprising a computer program configured to perform, control or enable one or more methods described herein.

### DESCRIPTION OF EXAMPLES

The present disclosure relates to navigation, and in particular to navigating moving objects in a three-dimensional (3D) scene such as drones or robots which are equipped with visual cameras and geographical location determination systems, such as global navigation satellite system (GNSS) positioning (such as that from Global Positioning System (GPS), Globalnaya Navigazionnaya Sputnikovaya Sistema (GLONASS), Galileo, or another GNSS system or systems, or land-based system using radio towers or mobile communications equipment. Throughout this description GPS is the GNSS referred to but other GNSS as mentioned above could be used). Such moving objects may be labelled “Intelligent Moving Platforms” (IMPs). IMPs may be used for surveillance, intelligent parking, or military purposes, for example. Accurately registering the position and heading/viewpoint/field of view of IMPs is important.

The claimed invention aims to solve the problem of obtaining an accurate geographical position and/or heading of an IMP from the geographical navigation positions of an IMP and a video sequence (such as a sequence of still frames) captured by a camera of the IMP. Challenges include: obtaining an accurate position (for example, with sub-meter accuracy) when geographical navigation position data (such as GPS data) may have as associated error of 10-20 meters per geographical navigation position data point; obtaining an accurate field of view/heading from a moving camera, when images captured from a moving camera can suffer from, for example, rolling shutters or lighting changes; and obtaining informative data from repetitive scenes (for example, if travelling through a parking lot, there may be many parking bays in a row which act as very similar geo-references which may not be informative). Such individual geographical navigation positions or visual cues may not, therefore, provide a reliable basis for determining a position and/or heading/field of view accurately.

Examples described herein use a multi-modal (i.e. both geographical navigation position data and visual/camera-captured data) 3D registration method to simultaneously localize a moving camera in a 3D scene and estimate its 3D orientation and heading/field of view.

Examples disclosed herein may be capable of localising IMPs with sub-meter accuracy, such as in crowded scenes (such as a parking-lot or a garden, which have a high number of visual cues such as parking bays, road markings, street furniture etc. (in a parking lot) or trees, branches, plants, steps, walkways etc. (in a garden)).

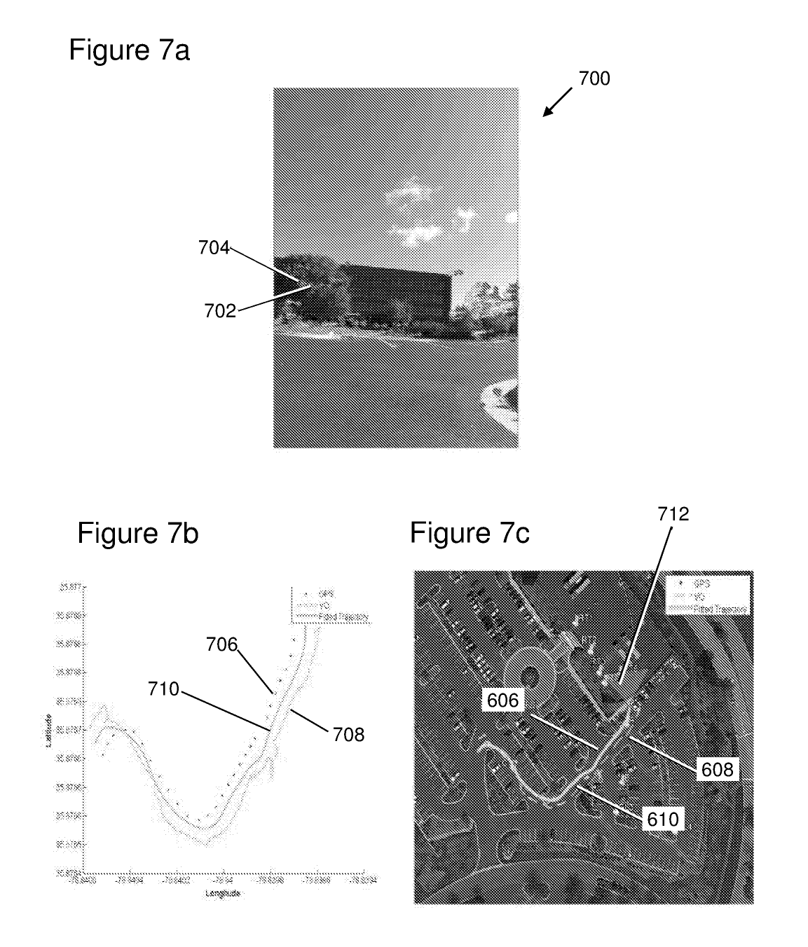

Examples disclosed herein may be capable of recovering camera orientation with respect to the ground, and/or a field of view, with high state-of-the-art quality. Example results from example apparatus and methods disclosed herein are shown in FIGS. 7a-c and 8a-c. In some examples (for example, if greedy initialisation is performed, by for example matching up visual cues between a series or sequence of frames in a particular window comprising a number of frames, rather than relying on visual cues from one frame only, the processing required to obtain such sub-meter accurate results may be computationally feasible for many IMPs, such as intelligent drones.

Examples disclosed herein may be used to recover accurate 3D geographical positions of geo-referenced moving objects (using less accurate 3D positioning technology) and 3D heading. Accurate positioning may be accurate to sub-meter precision in some examples. It is important to obtain high quality (e.g., accurate) registration results (i.e. registering/matching the geographical position and visual heading at a given time) for effective operation of moving objects, for example in surveillance applications. Such registration results may also be used for the self-localisation of moving objects such as portable electronic devices, intelligent vehicles (such as self-driving cars), robots or drones. A further application is to improve the localisation of moving objects such as robots and drones used for military or security applications by enabling the moving object access to multiple imaging sensors, such as object-mounted cameras and distributed cameras not mounted on/with the moving object, thereby improving awareness of the surrounding environment and security of the moving object.

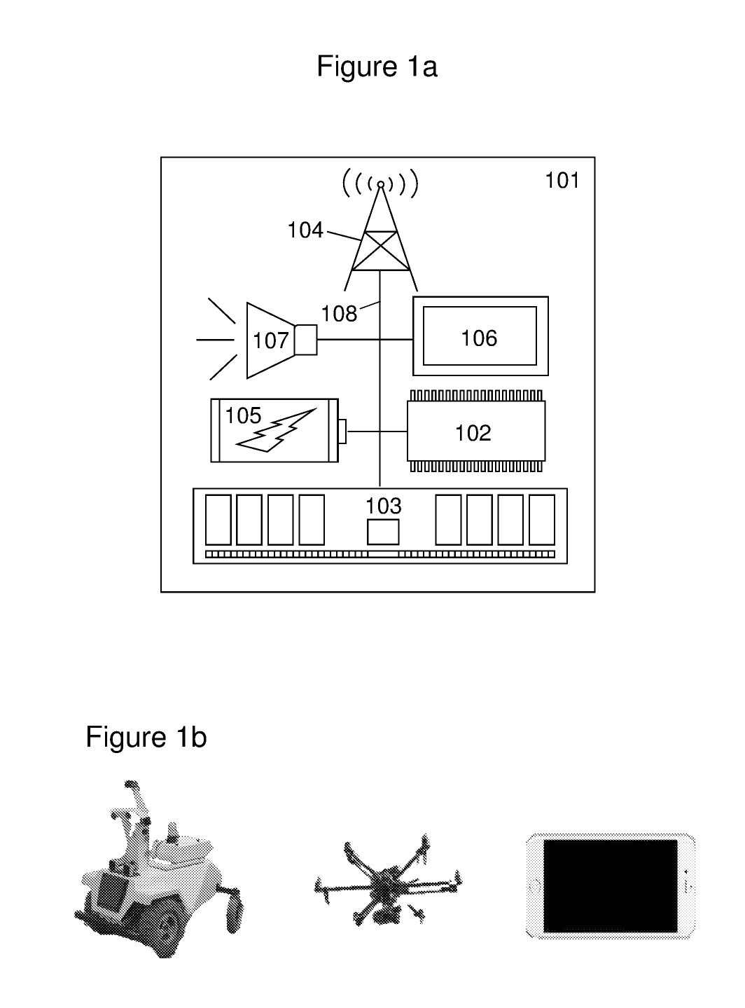

FIG. 1 shows an example apparatus 101 configured to perform one or more methods described herein. The apparatus 101 may be one or more of: a portable electronic device, a mobile telephone, a Smartphone, a tablet computer, a personal digital assistant, a laptop computer, a digital camera, a non-portable electronic device, a desktop computer, a server, or a module/circuitry for one or more of the same. In certain examples, the apparatus may comprise just a memory 103 and processor 102. In certain examples, the apparatus may be remote from and in communication with the moving object (for example, the apparatus may be a server in communication with a drone (the moving object)). In certain examples, the apparatus may be part of the moving object or may be the moving object (for example, the apparatus may be a computer on board a robot (the moving object)). In some examples all the method may be performed at a single apparatus, whereas in other examples different steps of the method may be performed by different apparatus in a distributed system.

The apparatus 101 is configured to, based on a plurality of geographical position data points associated with the position of a moving object; and based on a plurality of visual location data points obtained from a plurality of image frames captured from the moving object, the image frames showing a field of view of the moving object; determining a multi-modal trajectory by: matching the plurality of visual location data points with corresponding geographical navigation position data point of the plurality of geographical position data points; and determining the multi-modal trajectory as a best-fit trajectory having a deviation from the matched plurality of visual location data points and the plurality of geographical position data points within a predetermined tolerance; and smoothing the determined multi-modal trajectory to obtain a stable trajectory of the moving object, the stable trajectory indicative of a position and a heading of the moving object.

Throughout the present specification the term “trajectory” is used to mean a path which has been travelled by a moving object through space as a function of time. For example the trajectory of a car may be a path taken along roads which the car has driven along during the current or most recent journey.

In this example, the apparatus 101 comprises a processor 102, a memory 103, a transceiver 104, a power supply 105, and may comprise an electronic display 106 and a loudspeaker 107, which are electrically connected to one another by a data bus 108. The processor 102 is configured for general operation of the apparatus 101 by providing signalling to, and receiving signalling from, the other components to manage their operation. The memory 103 is configured to store computer program code configured to perform, control or enable operation of the apparatus 101. The memory 103 may also be configured to store settings for the other components. The processor 102 may access the memory 103 to retrieve the component settings in order to manage the operation of the other components. The processor 102 may be a microprocessor, including an Application Specific Integrated Circuit (ASIC). The memory 103 may be a temporary storage medium such as a volatile random access memory. On the other hand, the memory 103 may be a permanent storage medium such as a hard disk drive, a flash memory, or a non-volatile random access memory.

The transceiver 104 is configured to transmit data to, and/or receive data from, other apparatus/devices; for example, the apparatus may be remote from the moving object and may receive geographical navigation data and/or image data from the moving object via the transceiver. The power supply 105 is configured to provide the other components with electrical power to enable their functionality. The electronic display 106 may be an LED, e-ink, or LCD display, and is configured to display visual content, such as text or maps configured to provide navigation instructions which may be received by (e.g. via the transceiver) the apparatus 101. Similarly, the loudspeaker 107 is configured to output audio content which is stored on or received by the apparatus 101. In other examples, the display 106, loudspeaker 107 and any user interface components may be remote to, but in communication with, the apparatus 101 rather than forming part of the apparatus 101. Further, in other examples, the power supply 105 may be housed separately from the apparatus 101, and may be mains power.

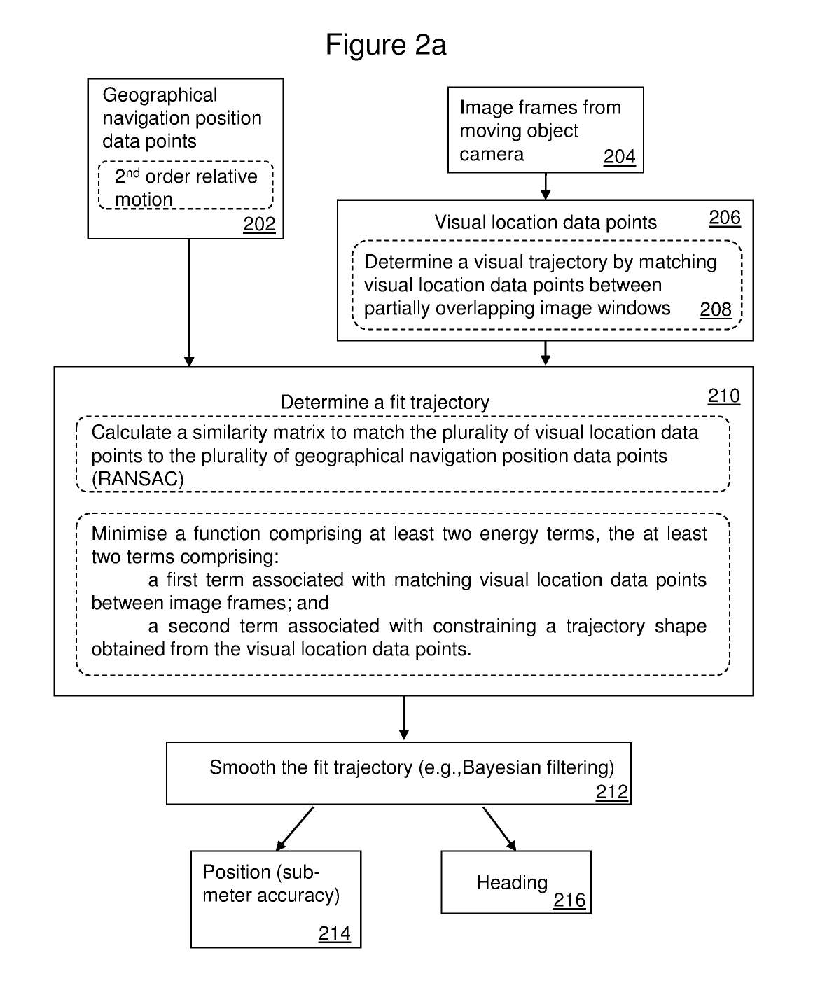

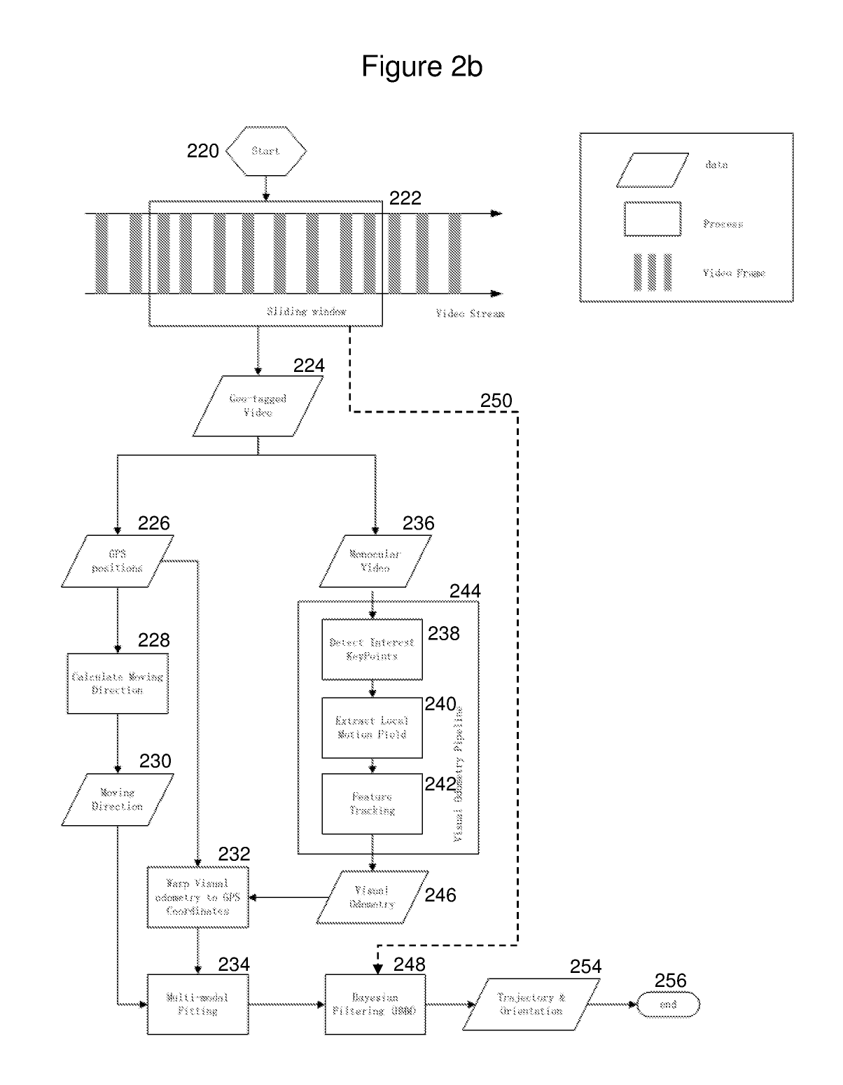

FIG. 2a illustrates schematically an example method which may be carried out by an apparatus. Overall, the method takes as input the position of the IMP along the trajectory as obtained using geographical navigation positioning 202 (the trajectory comprising a path in geographical space formed from intermittent data points), and a series of image frames 204 recorded along a trajectory, such as a monocular video sequence captured by a camera on board an IMP. As output, the method may provide refined camera positions/locations and refined camera orientations and heading/field of view information for providing an improved trajectory.

FIG. 2b illustrates an example algorithm which may be performed using a computer to obtain a stable trajectory of a moving object. At step 222, a window of video image frames is taken from the recorded video stream as the current window. The frames of the window 222 are analysed and points in the image frames are geo-tagged in step 224. That is, a plurality of visual location data points are obtained from a plurality of image frames 222 captured from the moving object. The GPS position data points 226 from the moving object (i.e. a plurality of geographical position data points associated with the position of a moving object) are used to calculate the moving direction of the moving object in step 228, from which the moving direction of the moving object is obtained 230.

Monocular video 236 of the geo-tagged video 224 is used in a visual odometry process 244 in which interesting key points in the monocular video are detected in step 238, then the local motion field of the moving object is extracted from the detected key points of interest in step 240. The local motion field is used for feature tracking in step 242, the output of which is visual odometry data 246 which is used in combination with the GPS positions 226 to warp the visual odometry data from the geo-tagged video to the GPS position data points in step 232. In step 234, the warped visual odometry data (a plurality of visual location data points) are matched/fit with corresponding geographical navigation position data points of the plurality of geographical position data points, by way of being matched/fitted with the GPS moving direction 230. This step comprises a multi-modal fitting 234 of the data from the GPS and visual sources. The multi-modal trajectory obtained from step 234 thus is determined from a plurality of visual location data points obtained from a plurality of image frames captured from the moving object (in the visual odometry pipeline 244).

Performing a multi-modal fitting 234 to obtain a multi-modal trajectory may be considered to be a step of identifying a best-fit trajectory having a deviation from the matched plurality of visual location data points and the plurality of geographical position data points within a predetermined tolerance.

The multi-modal fitted trajectory from step 234 is filtered in step 248, for example using Bayesian filtering, to obtain a stable trajectory and orientation of the moving object in step 254. The smoothing step 248 smooths the determined multi-modal trajectory to obtain a stable trajectory of the moving object 254. The trajectory is indicative of a position and a heading of the moving object. The process may then end 256.

FIG. 2b shows one pass of the method. In other examples, there may be a repeat of the method using a new series of visual image frames obtained by sliding the image window along by one or more image frames (hence the labelling of the visual image window 222 as a “sliding window”). It will be appreciated that the next window of frames may overlap by one or more frames with the previous window or the next window may not overlap. In some examples the number of frames used in the sliding window 222 is taken as an input in the filtering stage 248, shown by the optional dotted data path 250.

GPS (Geographical Navigation) Data (FIG. 2a, 202)

In some examples geographical navigation positions are used as geographical navigation positioning data (e.g., GPS positions). However, it may be advantageous to use the second-order relative motion obtained from the geographical navigation position data. This relative motion data may be extracted from the noisy geographical navigation position data as second-order relative changes of a series of geographical position data points obtained over a time period (i.e. the motion of the IMP is extracted and used to determine changes in position). Such changes of position/location (motion) may be less sensitive to noise and/or outliers than absolute geographical navigation positions, thereby providing a more accurate position less susceptible to noise present in the recorded geographical navigation position data. Noise and/or outliers may arise, for example, due to varying physical conditions, which can affect the position and give rise to an erroneous/inaccurate geographical navigation position data point being recorded. The second-order geographical navigation position data may be used and remain substantially accurate despite such errors in geographical navigation position determination provided that the moving direction is correctly/accurately obtained.

An outlier may be considered to be a geographical navigation position data point that is “distant” from other geographical position data points (for example, a data point which does not follow a common trend between the other “inlier” data points). Using second-order relative changes in geographical navigation (e.g., GPS) position contributes to regularising the optimisation procedure used to determine the position of the IMP accurately.

Based partly on a plurality of geographical position data points associated with the position of a moving object a stable trajectory of a moving object indicative of a position and a heading of the moving object can be obtained (in combination with a plurality of visual location data points). The plurality of geographical position data points may comprise the absolute position and/or the second order relative changes in absolute position, as determined using geographical navigation satellite system such as GPS.

Visual Odometry (FIG. 2a, 204)

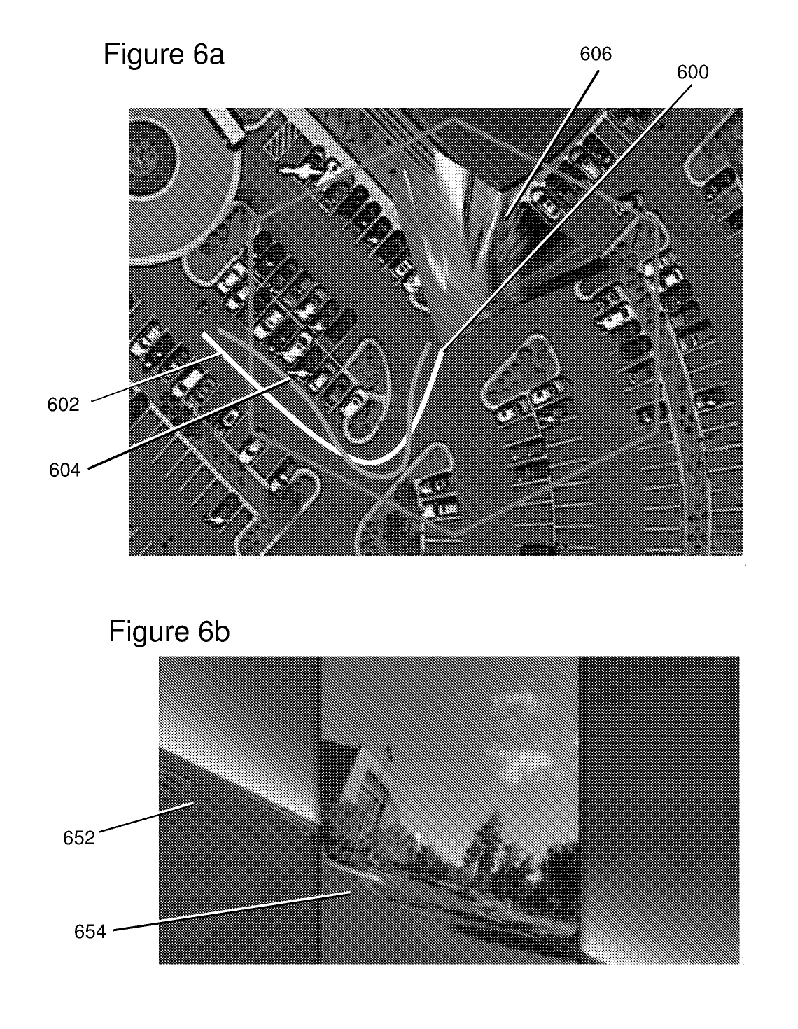

The image input 204 may be a series of image frames obtain from a video feed from the IMP. In each frame, a series of visual location data points may be identified 206 (examples are shown in FIGS. 6a and 7a). A visual location data point may be an image feature identifiable in a series of frames, such as the top of a lamppost, the rear-right wheel of a particular parked car, the corner of a building, or the top of a particular tree branch, for example. The process of determining the position and orientation of an IMP by analysing the associated camera images is called visual odometry (VO).

A visual trajectory shape may be determined 208 using visual odometry, by using the visual location data points. A visual location data point may be called a visual odometry data point.

In some examples the visual trajectory shape may be determined by identifying visual location data points in the plurality of image frames using image feature recognition and matching corresponding visual location data points between image frames in the plurality of consecutive image frames. A plurality of consecutive frames may be called an image window. The image window in some examples may comprise three or more image frames, and thus to obtain a visual trajectory, a comparison of the location of a particular identified visual location data point may be compared across more than two consecutive image frames. Obtaining a visual trajectory over a higher number of image frames may result in a more accurate visual trajectory being obtained.

In some examples a visual trajectory may be determined by, for a plurality of image windows offset from each other by at least one image frame, each image window comprising a plurality of consecutive image frames, identifying visual location data points in the plurality of image frames of each image window using image feature recognition, matching corresponding visual location data points between image frames in the plurality of consecutive image frames, and matching the corresponding visual location data points between image frames present in two or more overlapping image windows.

In some examples the number of image frames in an image window may be taken into account when smoothing the determined multi-modal trajectory. That is, the smoothing function applied to the multi-modal trajectory may be a function of the number of image frames used to determine the visual trajectory.

In some examples, corresponding visual location data points in consecutive frames may be identified using a scale invariant feature transform (SIFT) method and/or a speeded up robust features (SURF) method.

Using the SIFT method, for any object in an image, interesting points on the object can be extracted to provide a “feature description” of the object. This description, extracted from a training image, can then be used to identify the object when attempting to locate the object in a test image containing many other objects. To perform reliable recognition, it is important that the features extracted from the training image be detectable even under changes in image scale, noise and illumination. Such points usually lie on high-contrast regions of the image, such as object edges. SIFT may robustly identify objects even among clutter and under partial occlusion, because the SIFT feature descriptor can be invariant to uniform scaling, orientation, and partially invariant to affine distortion and illumination changes.

SURF is a local feature detector and descriptor that can be used for tasks such as object recognition or registration. It is related to the SIFT method. SURF may operate faster than SIFT in some examples and may be more robust against different image transformations than SIFT.

Thus in some examples, the visual data is processed by comparing overlapping portions of batches of multiple camera image frames with each other, rather than simply comparing individual pairs of frames with each other. Consistency constraints may be imposed between the corresponding frame pairs in the compared frame batches. For example, there may a constraint that a particular visual location data point identified in consecutive frames may be used provided it moves by 10% or less than the width of the frame between consecutive frames As another example, there may be a constraint that a measure of common features (such as the number of common features) between frames must be above a particular threshold (as a measure that the scenes captured in consecutive frames do not differ wildly). A further example of a consistency constraint may be that the relative positions of a group of visual location data points all differ between frames by a similar amount, or by an amount below a particular movement threshold. For a particular visual location data point, other spatially neighbouring visual location data points are likely to move in a similar direction by a similar amount to the particular visual location data point, and this information may be used as a consistency constraint. A more accurate result may be obtained by considering batches of frames rather than individual frame pairs.

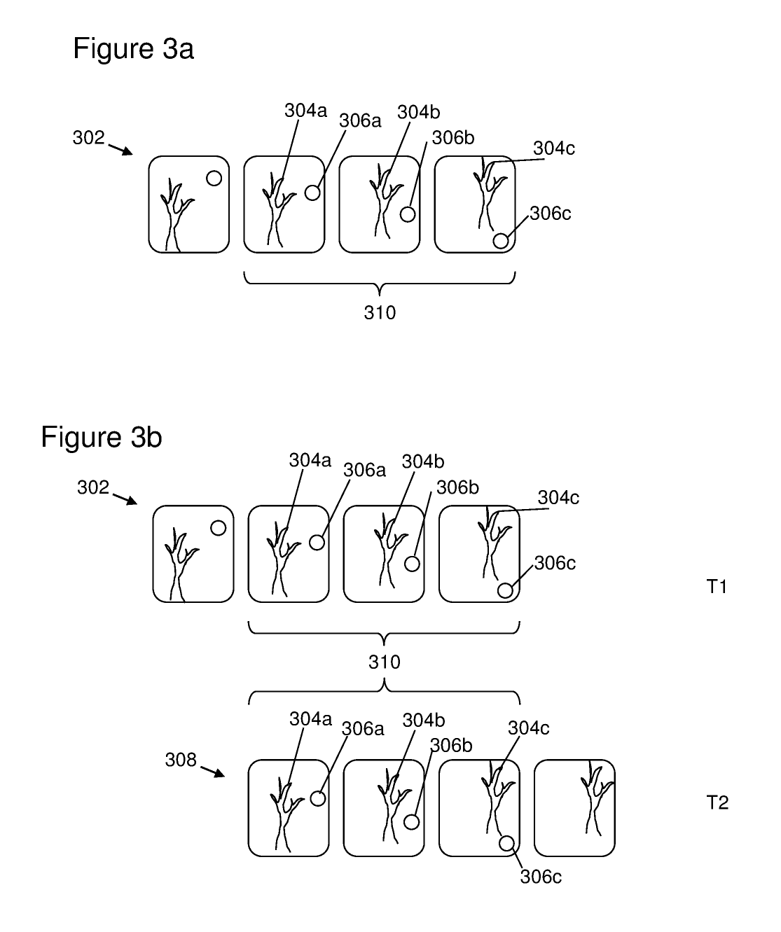

For example, FIG. 3a shows a series of four image frames 302 in an image window. The image window contains a series (in this example, four) consecutive image frames (i.e. an example of a plurality of image frames where the plurality is greater than two image frames). In each image frame there are identified two visual location data points, a tree branch tip 304a, b, c and a round object 306a, b, c. These visual location data points move location within the frame as time passes (for example, because an IMP is travelling past them). The apparatus may match corresponding visual location data points 304a, b, c; 306a, b, c (in this case, two points but it may be less or more) between the image frames in the image window. From this matching a visual trajectory may be obtained.

For example, FIG. 3b shows a series of four image frames 302 at time T1, and later a series of four image frames 308 at time T2. Each series of four image frames 302, 308 may be called an image window. There are three image frames in the T1 series which are matched with three corresponding image frames in the T2 series: these three frames may be called the partially overlapping portions of the image window 302, which overlaps the frames of T1 and T2. Each image window 302 contains a series (in this example, four) consecutive image frames. In each image frame there are identified two visual location data points, a tree branch tip 304a, b, c and a round object 306a, b, c.

The apparatus may match corresponding visual location data points 304a, b, c; 306a, b, c (in this case, two points but it may be less or more) between at least two partially overlapping image windows 302, 308. By using a visual trajectory determined from using the visual location data points 304a, b, c, 306a, b, c in the frames at time T1 as a starting point for the visual trajectory in the frames at time T2, a faster overall computation of the visual trajectory may be performed, which may provide more accurate results than if no overlapping windows are considered. The overlapping portion between windows (i.e. the number of image frames common to two or more image windows, the windows being at different positions in the overall image frame stream) in some examples may be more than one frame, as described in the examples below.

It may be imagined that corresponding visual location data points 304a, b, c; 306a, b, c may be matched up in a further third image window T3 (not shown) which is one frame along in time again from T2. The matching between image windows may be performed between determinations of a stable multi-modal trajectory of the moving object.

The examples above discussed in relation to FIGS. 3a and 3b relate to determining the visual trajectory only. The visual trajectory and the geographical navigation position (e.g., GPS) determined trajectory may be combined to obtain an accurate, stable multi-modal trajectory. That is, based partly on a plurality of visual location data points obtained from a plurality of image frames captured from the moving object, the image frames showing a field of view of the moving object, a stable trajectory of a moving object indicative of a position and a heading of the moving object can be obtained (in combination with a plurality of geographical position data points).

For example, at a time t, a window of the past 50 image frames (labelled frame 1 to frame 50) may be taken as the current window. Using this window of image frames, a method is performed comprising the steps of obtaining a corresponding plurality of geographical position data points, and based on these geographical position data points and a plurality of visual location data points obtained from the fifty image frames in the window, determining a multi-modal trajectory of the moving object (and in some examples then smoothing the trajectory to obtain a stable trajectory). The window may then be slid along by 10 frames to a next window of image frames (labelled frame 11 to frame 60) and the method is performed again with an overlap of 40 images frames between consecutive windows.

As another example a window (batch) of image frames may be taken as the current window. and a method performed as above (based on geographical position data points, and visual location data points obtained from the image frames in the window, determining a multi-modal trajectory of the moving object, and then smoothing the trajectory to obtain a stable trajectory, for example using Bayesian filtering). The window may then be slid along by e.g., 20 frames to a next window (batch) of image frames and the method is performed again. By performing the technique using an overlapping window (batch) portion from the previous method run-through, the results obtained from the previous method run-through may be used to initialise the current method run-through, thereby allowing for a quicker computation that if no previous results are used to initialise a current method/computation run-through. A larger batch size allows for more accurate stable trajectory calculation in part because a larger batch size of image frames reduced the effects of any noise present in the images. The skilled person will appreciate there is a trade-off between computational cost (which increases as the batch size and/or overlap region increases in size), and the accuracy of the stable trajectory obtained.

By matching corresponding visual location data points in multiple consecutive image frames rather than between individual frame pairs, the size of the window can be used as a parameter to control a subsequent smoothing of the determined position and/or heading using a Bayesian filtering framework.

To track visual location data points over time while preserving location spatial geometry, a “Loopy belief propagation algorithm” may be used to optimise the energy equation below. A belief propagation algorithm is a dynamic programming approach to answering conditional probability queries in a graphical model, for example of a trajectory travelled by an IMP. Let

I^{t}, I^{t+1} denote the intensity of a visual location data point at times t and t+1, with i visual location data points detected (i.e. the term i is used to index feature points in images). Let (xᵢ, yᵢ) denote the coordinate of the i^{th} point, let (i, j) ∈ ϵ denote two neighbouring points. The goal is to estimate the motion field (Δxᵢ, Δyᵢ), and the objective function has the following form:

$$E ( \{ Δ {x}_{i} , Δ {y}_{i} \} ) = {\sum }_{i} \vert \vert {I}^{t} ( {x}_{i} , {y}_{i} ) - {I}^{t + 1} ( {x}_{i} + Δ {x}_{i} , {y}_{i} + Δ {y}_{i} ) {\vert \vert}^{2} + λ \vert \vert ( Δ {x}_{i} , Δ {y}_{i} ) {\vert \vert}^{2} + β {\sum }_{( i , j ) ∈ z} [ \vert \vert Δ {x}_{i} - ← {u}_{j} \vert \vert + \vert \vert Δ {y}_{i} - Δ {v}_{j} \vert \vert ]$$

This function minimises appearance discrepancy (from the first term) and displacement (from the second term) and encourages spatial smoothness (from the third term) between neighbouring motion vectors (a motion vector is a vector between two corresponding visual location data points in consecutive frames, for example a vector between the locations in each frame of the top of a particular post in two consecutive image frames). This formula may be used to match visual location data points of interest across image frames. The function varies with respect to the local motion field (Δxᵢ, Δyᵢ) (that is, how a particular location data point changes position (moves) between frames). The equation is solved for the variables Δxᵢ, Δyᵢ. The motion field will determine the appearance discrepancy and displacement of visual location data points between frames, so by minimising the function E({Δxᵢ, Δyᵢ}) the appearance discrepancy is minimised.

Fit Trajectory (FIG. 2a, 210)

In some examples, an integer programing method is used to treat the obtained geographical navigation position data and visual odometry data, which may contribute to obtaining position and/or heading results with improved accuracy. Integer programming is an optimisation strategy when at least one of the variables are restricted to be integers.

Using the obtained geographical navigation position data to obtain a geographical navigation position based trajectory (in some examples by using the second-order relative motion of the IMP camera 202), and using the visual trajectory obtained by matching visual location data points 208, a fit trajectory may be determined. This fit trajectory may be termed a “multi-modal” trajectory as it combines the geographical navigation position data with the visual odometry data (i.e. two modes of data/positioning). The plurality of visual location data points obtained from the image data is matched with the corresponding geographical position data points of the plurality of geographical position data points.

This step aims to predict the trajectory of the IMP based on the geographical navigation position data and the visual odometry data. That is, this step aims to match the plurality of visual location data points with corresponding geographical position data points of the plurality of geographical position data points; and determine the multi-modal trajectory as a best-fit trajectory having a deviation from the matched plurality of visual location data points and the plurality of geographical position data points within a predetermined tolerance.

In this step there may be several problems to solve to predict the multi-modal trajectory. For example, geographical navigation position data is relatively sparse (for example, one geographical navigation position data point may be obtained for every 60 visual image frames that are captured) while the visual odometry position data is relatively dense (for example, one point per image frame). Further, geographical navigation position data can be noisy and it can be difficult to extract local movement (i.e., small-scale position changes along a large-scale trajectory) from such data. Also, visual odometry can provide data on local movement, but in metric space (a set for which distances between all members of the set are defined) rather than in meters (or latitude/longitude coordinates), so it is not trivial to align the visual odometry data with the geographical navigation position data.

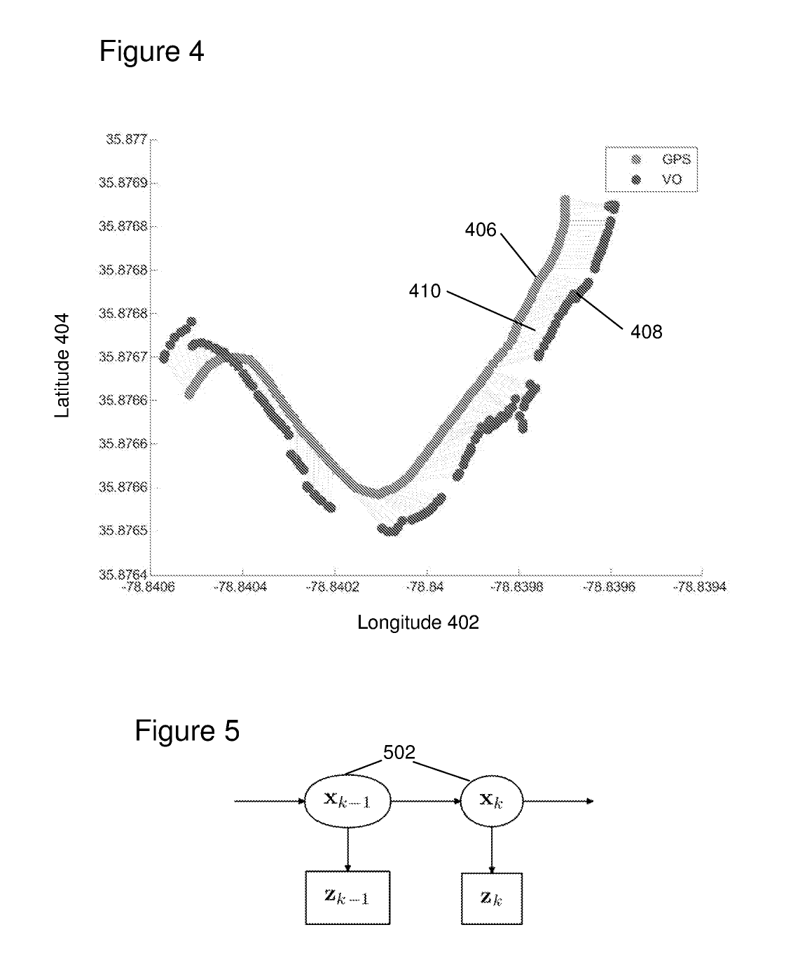

An example of fitting the multi-modal trajectory is shown in FIG. 4. This plot shows, on a longitude 402/latitude 404 set of axes, geographical position data points 406 and visual location data points 408. The plurality of geographical position data points 406 shown in FIG. 4 has been linearly interpolated to help the reader visualise a trajectory.

The plurality of visual location data points 408 shown in FIG. 4 may not be the complete set of visual location data points collected for the IMP trajectory. In this example only those visual location data points 408 which have a corresponding geographical navigation position data point 406 are shown. The links between pairs of geographical navigation position and visual location data points are shown as linking lines 410. The visual location data points 408 and the geographical position data points 406 may be paired up/linked by matching pairs of points with corresponding timestamps.

The geographical navigation position data and the visual odometry data may be plotted on the same axes to then determine a best fit multi-modal trajectory. This process may be called “matching” or “registering” the visual data and geographical navigation position data trajectories. The apparatus may be configured to match/register the plurality of visual location data points 408 with corresponding geographical position data points 406 of the plurality of geographical position data points by, at least in part, calculating a similarity matrix using the plurality of visual location data points 408 and the plurality of geographical position data points to minimise a difference between at least a subset of the plurality of visual location data points and the corresponding geographical position data points 406.

The plurality of visual location data points may be a subset of a plurality of initial visual location data points. In such cases the subset of initial visual location data points may exclude visual location data points from the plurality of initial visual location data points which are identified as lying outside a predetermined outlier threshold. In this way outliers may be removed from consideration in an aim to obtain more accurate results (ultimately a more accurate stable trajectory).

The similarity matrix may concern the rotation, scaling, and/or translation of the coordinates of the geographical navigation position data and the visual odometry data. The similarity matrix may be a transform matrix denoted M, with x̅₁, \hat{x}₁ denoting homogeneous coordinates of the visual location data point and geographical navigation position data point at time i, respectively. There results the following least squares problem:

$$arg {min}_{M} \vert \vert M * {\overline{x}}_{i} - {\hat{x}}_{i} {\vert \vert}^{2}$$

The matrix M may be used to match/register the estimated visual location data point at each time step with the GP geographical navigation positioning location data points (which are not available at each time step). Minimising this expression finds a best possible matrix that rotates, scales and/or translates the visual location data points, by minimising the squared distances between corresponding transformed visual location data points and geographical position data points.

In FIG. 4 the geographical position data points 406 and the visual location data points 408 are shown. The visual location data points 408 are actually “warped”; that is, the visual odometry data has been warped (using the similarity matrix to match up/register with the geographical position data points 406.

Thus FIG. 4 illustrates that the plurality of visual location data points are matched with a plurality of corresponding geographical position data points of the plurality of geographical position data points. This matching/registering is achieved, at least in part, by calculating a similarity matrix using the plurality of visual location data points and the plurality of corresponding geographical position data points to minimise a difference between at least a subset of the plurality of visual location data points and the plurality of corresponding geographical position data points.

Constraining the visual odometry trajectory obtained from the visual location data points to within a predetermined deviation from the visual location data points may be performed using a B-spline model to determine a smooth visual trajectory shape from the visual location data points. The visual location data points may be registered/matched to corresponding geographical position data points before spline-fitting the visual location data points.

An example B-spline model takes the form

$$τ ( t ) = {\sum }_{t} {α}_{i} {B}_{i} ( t )$$

where the spline function τ(t) is a linear combination of basis functions Bₗ where αₗ is a constant. In some examples, the first and second derivate of the B-spline model may be taken to be continuous; these high-order continuous constraints may be used to smooth the resulting visual trajectory. The order of the B-spline may be thus set at 3 for some examples.

The least squares problem discussed above may thus be expressed as

$$arg {min}_{\{ {α}_{t} \}} {\sum }_{t} \vert \vert M * {\overline{x}}_{t} - {\sum }_{t} {α}_{t} {B}_{t} ( t ) {\vert \vert}^{2} + γ {\sum }_{s , s + 1} {\sum }_{t} < {α}_{t} {B}_{t} ( s ) - {α}_{t} {B}_{t} ( s + 1 ) , {δ}_{< s , s + 1 >} >$$

where s is a geographical navigation position data point index, δ<s,s+1> denotes the relative motion from s to s+1 and represents the normal direction from the tangent plane at time s, and y is a constant. , δ<s,s+1> may be calculated offline. <αᵢBₜ(s)−αₜBₜ(s+1), δ_{<s,s+1}> is an inner product of two vectors, and minimising this inner product maximises the orthogonality of the two vectors. The multi-modal trajectory of the moving object may thus be determined by, at least in part, minimising a function such as the function expressed above which is associated with the multi-modal trajectory and comprises at least two energy terms.

The first term is used to interpolate the warped visual location data points 406 with the B-spline model and is associated with matching visual location data points between consecutive image frames.

The second term is associated with constraining a visual trajectory shape obtained from the visual location data points to within a predetermined deviation from the visual location data points. The second term is used to minimise the difference between the predicted direction of motion obtained from the visual location data points 408 and the direction obtained from the geographical position data points 406 between s to s+1. In some examples it may be applied over every three consecutive visual location data points. This step compares the direction and position points from the visual location data and geographical position data in order to reduce anomalous deviations above a predetermined acceptable threshold.

The equation above provides an example of a function associated with the multi-modal trajectory comprising at least two energy terms which may be minimised to provide the multi-modal trajectory. Such a function may be called a unified energy minimisation formula.

In some examples there may be a third energy term associated with constraining a direction obtained from the geographical position data points to be within a predetermined deviation from the original geographical position data points. That is, a third term may be used to minimise the difference between the predicted direction and the direction obtained from the geographical position data points 406 alone between s to s+1.

In general, it will be appreciated that an energy minimisation formula may be used comprising at least one or more of the following steps (other possible constraining determination may be performed):
a step constraining the visual trajectory shape obtained from visual location data points to a path within a predetermined acceptable deviation;
a step constraining the geographical position trajectory obtained from geographical position data points to within a predetermined acceptable deviation; and
a step constraining the visual trajectory shape and the geographical position trajectory to within an acceptable difference between the two trajectories.

This problem may be solved analytically, for example using a random sample consensus (RANSAC) method. A RANSAC method is an iterative method to estimate parameters of a mathematical model from a set of observed data which contains outliers.

The similarity matrix discussed above may be considered to be used for determining the multi-modal trajectory as a best-fit trajectory having a deviation from the matched plurality of visual location data points and the plurality of geographical position data points within a predetermined tolerance

Smoothing (FIG. 2a, 212)

The determined multi-modal trajectory is then smoothed to obtain a stable trajectory of the moving object. The stable trajectory is indicative of a position and a heading of the moving object.

In some examples, the determined position and/or heading may be smoothed using a Bayesian filtering framework to obtain filtered results. In particular, using Bayesian filtering may allow for a more accurate heading (e.g. orientation angle of the camera of the moving object) to be obtained. Using Bayesian filtering of the multi-modal trajectory may also allow for a more accurate (stable) trajectory to be obtained.

After obtaining the multi-modal trajectory from solving the abovementioned function, the determined multi-modal trajectory may be smoothed to obtain a stable (multi-modal) trajectory indicative of a position and a heading of the IMP. The smoothing may be performed over consecutive image windows as shown in FIG. 3.

An example smoothing technique is Bayesian filtering (a particular form of the Hidden Markov Model, HMM which is illustrated in FIG. 5). The technique may be used to estimate the rotation angle with respect to the ground level (related to the heading of the IMP), assuming the camera pan and tilt angles are fixed with respect to the IMP on/in which it is mounted. In contrast with other smoothing techniques the HMM has flexibility to deal with multi-variant outputs (e.g., from both geographical navigation position data and visual odometry data) and prior distributions (e.g., from a data set at time t, and a subsequent data set at time t+δt). Other smoothing techniques include using a Kalman filter, using a Particle filter, and variants thereof.

A general architecture of the Hidden Markov Model is illustrated in FIG. 5. Each oval shape 502 represents a random variable that can adopt any of a number of values. The random variable x(k) is the hidden state at point k, and the random variable z(k) is the observation at point k. The arrows in FIG. 5 denote conditional dependencies.

A mathematical example is thus: let xₜ denote the initial estimate of position from the visual location data points 408 at each time step t ∈[1 . . T]. The corresponding joint distribution has the form:

$$p ( {z}_{1 \text{:} T} , {X}_{1 \text{:} T} ) = p ( {z}_{1 \text{:} T} ) p ( {x}_{1 \text{:} T} \vert {z}_{1 \text{:} T} ) = p ( {z}_{1} ) {Π}_{2}^{T} p ( {z}_{t} \vert {z}_{t - w + 1 \text{:} t - 1} ) {\prod }_{t = 1}^{T} p ( {x}_{t} \vert z [ t - w \text{:} t ] )$$

where p(zₜ|z_{t-w+1:t-1}) is the transition model and p(xₜ|zₜ) is the visual location, or observational, model. zₜ represents orientation angle.

In some examples the prior model p(z₁) is uniform, and may not be an arbitrary direction (for example, the direction may be constrained to remain along a road). The prior model may be extracted from a background scene

In some examples the transition model p(zₜ|zₜ₋₁) follows a linear motion model. This is used to predict the position z of the IMP at time T given a particular motion parameter based on a previous position. The transition model describes the probability of moving from one state to another state, and is usually assumed to follow a Gaussian distribution.

In some examples the observational model is pooled from the past w time steps, parameterised as a conditional Gaussian distribution, i.e. p(xₜ|z_{[t-w:t]})=N(xₜ|uₖ, Σₖ). The observational model is used to predict the current state from past visual observations (and is sometimes called a “likelihood model”).

The parameters may be obtained from training data, for example by the Maximise Likelihood method (which considers the maximum likelihood estimate for a model's parameters for a given data set.)

FIG. 6a illustrates a comparison of the results of determine the trajectory of an IMP through a parking lot using geographical navigation positioning alone, and by using methods as described above. The IMP is currently at the position 600 in the parking lot with a particular field of view 606. The trajectory 604 is based on the geographical navigation positions measured during the movement of the IMP. The trajectory 602 is based on considering the second order relative movement obtained from the geographical navigation positions measured and visual odometry data obtained during the movement of the IMP, finding a best fit trajectory from both sets of data (geographical navigation positions and visual odometry positions) and then smoothing the resulting fit trajectory using Bayesian filtering to obtain the stable trajectory 602. It can be seen that the stable trajectory 602 provides a more accurate trajectory than the trajectory obtained from geographical navigation positioning alone 604.

FIG. 6b illustrates the current frame 654 captured using an IMP camera overlaid onto a “warped scene map” 652, which may be obtained by using visual odometry data captured during the immediately previous portion of IMP travel and warping it (for example as discussed in relation to FIG. 4 to match the geographical navigation positioning data captured during the same portion of travel.) It can be seen that the current image matches up well with the warped scene map, thereby demonstrating that the “warping” technique described allows the visual odometry data used in determining a stable trajectory to agree well with the real-life positioning. This image also demonstrates that by treating the visual odometry and geographical navigation position data as described above allows the expected heading to be accurately determined.

FIGS. 7a-7c illustrate a real-life example of the abovementioned examples in practice. In FIG. 7a, a visual image 700 is shown which has been captured as a video frame by a video camera mounted on a moving object. Several visual location data points have been identified in the image 700, for example relating to building corners, tree branch features and parking road markings. The visual location data points shown as filled circles 702 indicate the location of visual location data points in the immediately preceding image frame, and visual location data points shown as open circles 704 indicate the location of the corresponding visual location data points in the current image frame. A comparison has been made between the immediately previous image frame and the current image frame 700 and used to determine a visual trajectory.

FIG. 7b illustrates, similarly to FIG. 4, a longitude/latitude graph. Geographical position data points 606 recorded during the movement of the moving object are plotted (these geographical position data points may represent the second-order movement of the moving object as discussed above). Warped visual location data points 708 extracted from the video images as in FIG. 7a and warped to be co-plotted with the geographical position data points 706 are also plotted on the graph. Using the matched geographical position data points 706 and the warped visual odometry data 708, a multi-modal fit trajectory 710 of the moving object is determined as a best-fit trajectory having a deviation from the matched plurality of visual location data points and the plurality of geographical position data points within a predetermined tolerance. This trajectory is then smoothed, for example using a Bayesian fitting method, to obtain a stable trajectory of the moving object which is plotted on a map of the location of movement of the moving object in FIG. 7c (along with the geographical navigation position data and the warped visual odometry data as in FIG. 7b). It can be seen from the plotted trajectories 606, 608, 610 that the moving object turned right, travelled between a series of parking bays to either side, then made a left turn to travel along a road to reach a particular parking bay. The current camera/visual field of view 712 of the moving object is also illustrated in FIG. 7c.

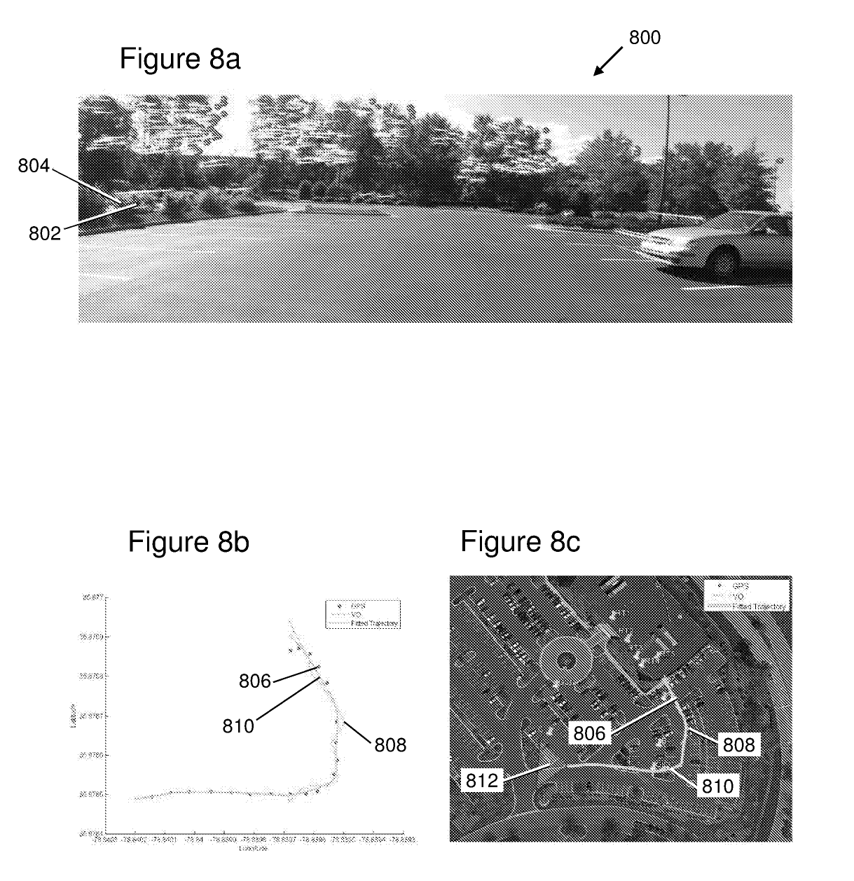

FIGS. 8a-8c illustrate a second real-life example of the abovementioned examples in practice similarly to the example shown in FIG. 7a-c. In FIG. 8a, a visual image 800 is shown with several visual location data points identified in the image 800, for example relating to parked car features, tree branch features and street furniture. The visual location data points shown as filled circles 802 indicate the location of visual location data points in the immediately preceding image frame, and visual location data points shown as open circles 804 indicate the location of the corresponding visual location data points in the current image frame. A comparison has been made between the immediately previous image frame and the current image frame 800 and used to determine a visual trajectory.

FIG. 8b illustrates, similarly to FIGS. 4 and 7b, a longitude/latitude graph. Geographical position data points 806 recorded during the movement of the moving object are plotted. Warped visual location data points 808 extracted from the video images as in FIG. 8a and warped to be co-plotted with the geographical position data points 806 are also plotted on the graph. Using the matched geographical position data points 806 and the warped visual odometry data 808, a multi-modal fit trajectory 810 of the moving object is determined as a best-fit trajectory having a deviation from the matched plurality of visual location data points and the plurality of geographical position data points within a predetermined tolerance. This trajectory is then smoothed to obtain a stable trajectory of the moving object which is plotted on a map of the location of movement of the moving object in FIG. 8c (along with the geographical navigation position data and the warped visual odometry data as in FIG. 8b). It can be seen that the moving object started from the end point reached in FIG. 7c, travelled across a road and past parking bays to either side, then turned right to move along past some more parking bays to the left of the moving object before stopping at a small grass island in the parking lot. The estimated current heading 812 of the moving object is also illustrated in FIG. 8c, as determined using the smoothed stable multi-modal trajectory 810.

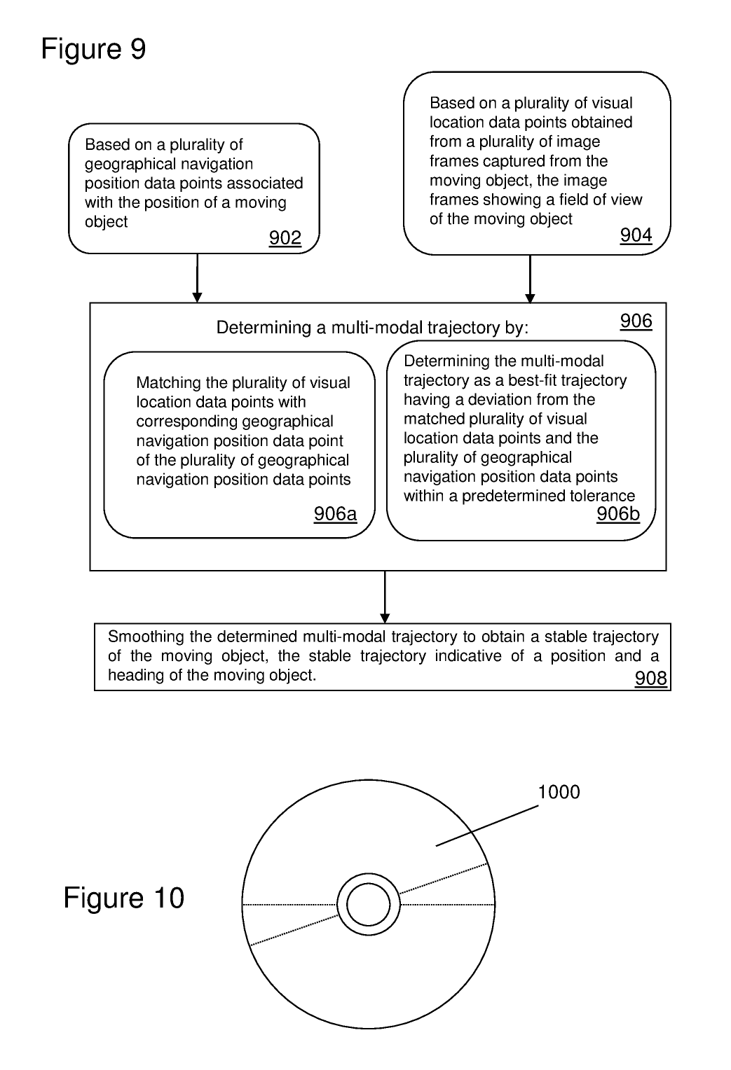

FIG. 9 illustrates an example method, comprising the steps of: based on a plurality of geographical position data points associated with the position of a moving object; and based on a plurality of visual location data points obtained from a plurality of image frames captured from the moving object, the image frames showing a field of view of the moving object 904; determining a multi-modal trajectory 906 by: matching the plurality of visual location data points with corresponding geographical navigation position data point of the plurality of geographical position data points 906a; and determining the multi-modal trajectory as a best-fit trajectory having a deviation from the matched plurality of visual location data points and the plurality of geographical position data points within a predetermined tolerance 906b; and smoothing the determined multi-modal trajectory to obtain a stable trajectory of the moving object, the stable trajectory indicative of a position and a heading of the moving object 908.

FIG. 10 illustrates a computer/processor readable medium 1000 providing a computer program according to one example. The computer program may comprise computer code configured to perform, control or enable a method described herein. In this example, the computer/processor readable medium 1000 is a disc such as a digital versatile disc (DVD) or a compact disc (CD). In other examples, the computer/processor readable medium 1000 may be any medium that has been programmed in such a way as to carry out an inventive function. The computer/processor readable medium 1000 may be a removable memory device such as a memory stick or memory card (SD, mini SD, micro SD or nano SD). In some examples, the computer program may be embodied over a distributed system, for example partially on the moving object and partially on a remote server in communication with the moving object.

Any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

Any mentioned apparatus/circuitry may have other functions in addition to the mentioned functions, and that these functions may be performed by the same apparatus/circuitry. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognised that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-15. (canceled)

16. An apparatus comprising a processor and memory including computer program code, the memory and computer program code configured to, with the processor, enable the apparatus at least to:
based on a plurality of geographical position data points associated with the position of a moving object; and
based on a plurality of visual location data points obtained from a plurality of image frames captured from the moving object, the image frames showing a field of view of the moving object;
determine a multi-modal trajectory by:
matching the plurality of visual location data points with corresponding geographical position data points of the plurality of geographical position data points; and
determining the multi-modal trajectory as a best-fit trajectory having a deviation from the matched plurality of visual location data points and the plurality of geographical position data points within a predetermined tolerance; and
smooth the determined multi-modal trajectory to obtain a stable trajectory of the moving object, the stable trajectory indicative of a position and a heading of the moving object; and
determine a visual trajectory shape by, at least in part:
identifying visual location data points in the plurality of image frames using image feature recognition; and
matching corresponding visual location data points between image frames in the plurality of consecutive image frames.

17. The apparatus of claim 16, wherein the apparatus is configured to provide the stable trajectory of the moving object with sub-meter accuracy.

18. The apparatus of claim 16, wherein the apparatus is configured to match the plurality of visual location data points with a plurality of corresponding geographical position data points of the plurality of geographical position data points by, at least in part,
calculating a similarity matrix using the plurality of visual location data points and the plurality of corresponding geographical position data points to minimise a difference between at least a subset of the plurality of visual location data points and the plurality of corresponding geographical position data points.

19. The apparatus of claim 18, wherein the apparatus is configured to calculate the similarity matrix using a random sample consensus (RANSAC) method.

20. The apparatus of claim 16, wherein the apparatus is configured to determine the multi-modal trajectory by, at least in part, minimising a function associated with the multi-modal trajectory comprising at least two energy terms, the at least two terms comprising:
a first term associated with matching visual location data points between consecutive image frames; and
a second term associated with constraining a visual trajectory shape obtained from the visual location data points to within a predetermined deviation from the visual location data points.

21. The apparatus of claim 20, wherein constraining the visual trajectory shape obtained from the visual location data points to within a predetermined deviation from the visual location data points comprises using a B-spline model to determine a smooth visual trajectory shape from the visual location data points.

22. The apparatus of claim 20, wherein the apparatus is configured to determine the visual trajectory shape by, at least in part:
for a plurality of image windows offset from each other by at least one image frame, each image window comprising a plurality of consecutive image frames:
identifying at least one visual location data point in the plurality of image frames of each image window using image feature recognition;
matching corresponding visual location data points between image frames in the plurality of consecutive image frames;
matching the corresponding visual location data points between image frames present in two or more overlapping image windows; and
smoothing the determined multi-modal trajectory based on the number of image frames in the plurality of image frames of an image window.

23. The apparatus of claim 16, wherein the apparatus is configured to smooth the multi-modal trajectory by, at least in part, using Bayesian filtering.

24. The apparatus of claim 16, wherein the plurality of geographical position data points comprise second order relative motion geographical navigation data points derived from a plurality of absolute geographical navigation positions.

25. The apparatus of claim 16, wherein the plurality of visual location data points is a subset of a plurality of initial visual location data points, the subset of initial visual location data points excluding visual location data points from the plurality of initial visual points which are identified as lying outside a predetermined outlier threshold.

26. A method comprising:
based on a plurality of geographical position data points associated with the position of a moving object; and
based on a plurality of visual location data points obtained from a plurality of image frames captured from the moving object, the image frames showing a field of view of the moving object;
determining a multi-modal trajectory by:
matching the plurality of visual location data points with corresponding geographical navigation position data point of the plurality of geographical position data points; and
determining the multi-modal trajectory as a best-fit trajectory having a deviation from the matched plurality of visual location data points and the plurality of geographical position data points within a predetermined tolerance; and
smoothing the determined multi-modal trajectory to obtain a stable trajectory of the moving object, the stable trajectory indicative of a position and a heading of the moving object; and
determining a visual trajectory shape by, at least in part for a plurality of image windows offset from each other by at least one image frame, each image window comprising a plurality of consecutive image frames.

27. The method of claim 26, wherein the method provides the stable trajectory of the moving object with sub-meter accuracy.

28. The method of claim 26, wherein the method matches the plurality of visual location data points with a plurality of corresponding geographical position data points of the plurality of geographical position data points by, at least in part,
calculating a similarity matrix using the plurality of visual location data points and the plurality of corresponding geographical position data points to minimise a difference between at least a subset of the plurality of visual location data points and the plurality of corresponding geographical position data points.

29. The method of claim 28, wherein the method calculates the similarity matrix using a random sample consensus (RANSAC) method.

30. The method of claim 26, wherein the method determines the multi-modal trajectory by, at least in part, minimising a function associated with the multi-modal trajectory comprising at least two energy terms, the at least two terms comprising:
a first term associated with matching visual location data points between consecutive image frames; and
a second term associated with constraining a visual trajectory shape obtained from the visual location data points to within a predetermined deviation from the visual location data points.

31. The method of claim 30, wherein the method further constrains the visual trajectory shape obtained from the visual location data points to within a predetermined deviation from the visual location data points comprises using a B-spline model to determine a smooth visual trajectory shape from the visual location data points.

32. The method of claim 30, wherein the method further determines the visual trajectory shape by, at least in part:
for a plurality of image windows offset from each other by at least one image frame, each image window comprising a plurality of consecutive image frames:
identifying at least one visual location data point in the plurality of image frames of each image window using image feature recognition;
matches corresponding visual location data points between image frames in the plurality of consecutive image frames; and
matches the corresponding visual location data points between image frames present in two or more overlapping image windows, wherein the method smooths the determined multi-modal trajectory based on the number of image frames in the plurality of image frames of an image window

33. The method of claim 30, wherein the method further smooths the multi-modal trajectory by, at least in part, using Bayesian filtering.

34. The method of claim 30, wherein the plurality of geographical position data points comprise second order relative motion geographical navigation data points derived from a plurality of absolute geographical navigation positions.

35. The method of claim 30, wherein the plurality of visual location data points is a subset of a plurality of initial visual location data points, the subset of initial visual location data points excluding visual location data points from the plurality of initial visual points which are identified as lying outside a predetermined outlier threshold.
